(19) United States
(12) Patent Application Publication
(10) Pub. No.: US 2014/0162727 A1
(43) Pub. Date: Jun. 12, 2014

(54) SIGNAL CONVERSION DEVICE, SIGNAL CONVERSION METHOD AND TERMINAL DEVICE

(71) Applicant: SONY CORPORATION, Tokyo (JP)

(72) Inventors: Takehiko Saito, Kanagawa (JP); Akihiko Tao, Kanagawa (JP); Takamichi Mitsuhashi, Tokyo (JP)

(73) Assignee: SONY CORPORATION, Tokyo (JP)

(21) Appl. No.: 14/235,226

(22) PCT Filed: Aug. 16, 2012
(86) PCT No.: PCT/JP2012/070862

§ 371 Date: Jan. 27, 2014

(30) Foreign Application Priority Data
Aug. 23, 2011 (JP) 2011-181107

(51) Int. Cl. H04M 1/02

(52) U.S. Cl. CPC H04M 1/0274
USPC 455/559

(57) ABSTRACT

An improvement in user convenience is achieved.

A signal conversion unit converts a first transmission specification signal that is input from a first external device, into a second transmission specification signal. For example, in the first transmission specification, video data and audio data are transmitted using one pair of differential signal lines, and, in the second transmission specification, video data and audio data are transmitted using three pairs of differential signal lines. The first transmission specification signal that is input from the first external device or the second transmission specification signal that is obtained by the signal conversion unit is selected as an output signal by a signal selection unit. A control unit controls the selection operation performed by the signal selection unit, in accordance with a transmission specification with which a second external device to which the output signal is to be supplied is compatible.

### TECHNICAL FIELD

The present technology relates to a signal conversion device, a signal conversion method, and a terminal device, and particularly relates to a signal conversion device and the like provided and used between electronic devices.

### BACKGROUND ART

In recent years, for example, interfaces such as High-Definition Multimedia Interface (HDMI) are becoming widespread as communication interfaces for transmitting video and audio data at high speed from a source device to a sink device. A source device is, for example, a game device, a digital versatile disc (DVD) recorder, a set-top box, or another audio visual source (AV source). A sink device is, for example, a television receiver, a projector, or another display. For example, Non-Patent Document 1 describes the HDMI specification in detail.

### CITATION LIST

### Non-Patent Document

Non-Patent Document 1: High-Definition Multimedia Interface Specification Version 1.3, Jun. 22 2006

### SUMMARY OF THE INVENTION

### Problems to be Solved by the Invention

The HDMI specification mainly assumes that connection is performed between fixed devices. Therefore, the number of connector pins is large at 19, and the external dimensions of connectors are also large, which is a drawback for mobile devices. Thus, investigations have begun for a new specification for reducing the size of connectors by having a small number of pins, and also for performing baseband video transmission that is equivalent to HDMI.

For sink devices such as television receivers, adding a connector of a new specification would harm user convenience and would also be a drawback from the aspects of space and cost. It would be convenient if the HDMI receptacles that have become widespread digital A/V input ports could also be used under the new specification. For this purpose, it is thought that, in sink devices such as television receivers, compatibility with a new specification can be made possible by only the circuits while also using conventional HDMI receptacles.

For example, it is thought that in the case where a new specification-compatible (compatible with both HDMI and the new specification) television receiver and a new specification-compatible mobile phone are connected, the television receiver and the mobile phone can be directly connected by using a new-specification cable. Furthermore, for example, it is thought that in the case where a new specification-incompatible (compatible with only HDMI) television receiver a new specification-compatible mobile phone are connected, an HDMI cable and a dongle (signal conversion device) having a new-specification/HDMI conversion circuit can be used to implement an HDMI connection.

In this case, for example, if a user has made a mistake and used a dongle and an HDMI cable to connect a new specification-compatible (compatible with both HDMI and the new specification) television receiver and a new specification-compatible mobile phone, it would be convenient if a new-specification connection were automatically performed. It would therefore be possible to avoid being unable to use the functions specific to the new specification, and convenience for the user would improve.

A purpose of the present technology lies in achieving an improvement in user convenience.

### Solutions to Problems

The concept of the present technology lies in

a signal conversion device including:

a signal conversion unit that converts a first transmission specification signal that is input from a first external device, into a second transmission specification signal;

a signal selection unit that selects, as an output signal, the first transmission specification signal that is input from the first external device or the second transmission specification signal that is obtained by the signal conversion unit; and

a control unit that controls the selection operation performed by the signal selection unit, in accordance with a transmission specification with which a second external device, to which the output signal selected by the signal selection unit is to be supplied, is compatible.

In the present technology, a first transmission specification signal that is input from the first external device is converted into a second transmission specification signal by the signal conversion unit. For example, in the first transmission specification and the second transmission specification, video data and audio data are transmitted on a differential signal line and, in addition, a control signal is transmitted on a separate signal line. In this case, for example, in the first transmission specification, a first transmission specification signal is transmitted using a first number of signal lines, and, in the second transmission specification, a second transmission specification signal is transmitted using a second number of signal lines that is greater than the first number.

Then, in this case, for example, in the first transmission specification, video data and audio data are transmitted using one pair of differential signal lines, and, in the second transmission specification, video data and audio data are transmitted using three pairs of differential signal lines. Here, for example, the second transmission specification is HDMI, and the first transmission specification is a new specification in which the connector has a smaller number of pins.

The first transmission specification signal that is input from the first external device or the second transmission specification signal that is obtained by the signal conversion unit is selected as an output signal by the signal selection unit. The selection operation performed by the signal selection unit is then controlled by the control unit. In this case, in the control unit, the selection operation performed by the signal selection unit is controlled in accordance with the transmission specification with which the second external device, to which the output signal is to be supplied, is compatible.

In this case, for example, in the control unit, when the second external device is compatible with the first transmission specification, control is performed in such a way that the signal selection unit outputs the first transmission specification signal. In this case, for example, in the control unit, the impedance of the second external device is detected to thereby determine whether or not this second external device is compatible with the first transmission specification.

In this way, in the present technology, the first transmission specification signal that is input from the first external device or the second transmission specification signal that is obtained by the signal conversion unit is set as an output signal in accordance with the transmission specification with which the second external device is compatible. Therefore, when the first external device is compatible with the first transmission specification, and the second external device is compatible with the first transmission specification, a state is entered in which the first external device and the second external device are directly connected by the first transmission specification, and a state is entered in which the functions specific to the first transmission specification can be used. Consequently, in the present technology, it is possible to achieve an improvement in user convenience.

Moreover, for example, the present technology may be configured so as to be further provided with a power receiving unit that receives, from the first external device or the second external device, power to be supplied to an internal circuit. In this case, for example, a power line for supplying power to the internal circuit and the first external device further including, and power is supplied from this second external device to the power line when the second external device is compatible with the first transmission specification. Then, in this case, for example, a resistor for prompting the second external device to supply power further including, and the second external device supplies power to the power line by detecting this resistor. As a result of the power receiving unit being provided in this way, operation becomes possible without receiving a supply of power from an external power source such as an AC adapter.

Furthermore, for example, the present technology may be configured so as to be further provided with: a power input unit for supplying power from an external power source to the power line; and a power interference prevention unit that prevents interference between power input from the second external device and power input from the external power source. In this case, for example, the power interference prevention unit is a diode bridge including a first diode that is inserted in a power supply path from the second external device to the power line, and a second diode that is inserted in a power supply path from the power input unit to the power line. In this case, it becomes possible to supply power in a satisfactory manner also from an external power source such as an AC adapter.

Furthermore, another concept of the present technology lies in

a terminal device including:

a battery;

a charging unit that charges the battery;

a power terminal;

a state selection unit that selects a first connection state in which the power terminal is connected to the charging unit or a second connection state in which output of the battery is connected to the power terminal; and

a control unit that controls the selection operation performed by the state selection unit,

wherein the control unit controls the selection operation performed by the state selection unit, in such a way that the second connection state is selected when the voltage of the power terminal is lower than a specified value in a state in which the first connection state is selected.

In the present technology, the first connection state in which the power terminal is connected to the charging unit of the battery or the second connection state in which the output of the battery is connected to the power terminal is selected by the state selection unit. The selection operation performed by this state selection unit is controlled by the control unit. In this case, the selection operation performed by the state selection unit is controlled in such a way that the second connection state is selected when the voltage of the power terminal is lower than the specified value in a state in which the first connection state is selected. It therefore becomes possible to supply power to an external device from the battery via the power terminal when there is no supply of power from an external device.

Moreover, for example, the present technology may be configured in such a way that, when the second connection state is selected, the control unit controls the selection operation performed by the state selection unit, in such away that the first connection state is selected, on the basis of a notification of power supply from an external device that supplies power to the power terminal. Then, for example, a signal output unit that outputs a first transmission specification signal further including, and the external device has a function that converts the first transmission specification signal that is output from the signal output unit, into a second transmission specification signal.

### Effects of the Invention

According to the present technology, it is possible to achieve an improvement in user convenience.

### BRIEF DESCRIPTION OF DRAWINGS

FIG. 1 is a block diagram showing an exemplary configuration of an AV system in which a source device and a sink device are connected by a cable.

FIG. 2 is a diagram showing an exemplary configuration of a data transmitting unit of a source device and a data receiving unit of a sink device in an AV system (in the case of an HDMI-specification digital interface).

FIG. 3 is a diagram showing an example of the structure of TMDS transmission data that is transmitted in an HDMI TMDS channel.

FIG. 4 is a diagram showing the pin arrangement (type A) of an HDMI terminal provided in an HDMI device.

FIG. 5 is a diagram showing an exemplary configuration of a data transmitting unit of a source device and a data receiving unit of a sink device in an AV system (in the case of a new-specification digital interface).

FIG. 6 is a diagram showing an example of a driver configuration in a transmitter, and a receiver configuration in a receiver.

FIGS. 7(a), 7(b), and 7(c) are diagrams showing an example of a single-ended waveform on a cable, a data differential waveform, and a clock common-mode waveform.

FIGS. 8(a) and 8(b) are diagrams for illustrating the relationship between a TMDS clock and an internal clock in HDMI and a new specification.

FIG. 9 is a block diagram showing an exemplary configuration of an AV system in which a new specification-compatible mobile phone and a new specification-compatible television receiver are connected by a new-specification cable.

FIG. 10 is a diagram for illustrating an impedance detection procedure in a control circuit of a mobile phone and a control circuit of a television receiver.

FIG. 11 is a block diagram showing an exemplary configuration of an AV system in which a dongle is provided between a new specification-compatible mobile phone and a new specification-incompatible (HDMI compatible) television receiver.

FIG. 12 is a diagram for illustrating the bidirectional conversion of CEC, DDC, and HPD line signals in HDMI and a CBUS line signal in a new specification by a new-specification/HDMI conversion circuit and a control circuit.

FIG. 13 is a block diagram showing an exemplary configuration of an AV system in which a dongle is provided between a new specification-compatible mobile phone and a new specification-compatible television receiver.

FIG. 14 is a block diagram showing an exemplary configuration of an AV system serving as an embodiment of the present technology, in which a dongle is provided between a new specification-compatible mobile phone and a new specification-compatible television receiver.

FIG. 15 is a diagram for illustrating an impedance detection procedure in a control circuit of a mobile phone and a control circuit of a dongle.

FIG. 16 is a block diagram showing another exemplary configuration of an AV system serving as an embodiment of the present technology, in which a dongle is provided between a new specification-compatible mobile phone and a new specification-incompatible television receiver.

FIG. 17 is a block diagram showing another exemplary configuration of an AV system serving as an embodiment of the present technology, in which a dongle is provided between a new specification-compatible mobile phone and a new specification-compatible television receiver.

### MODE FOR CARRYING OUT THE INVENTION

A mode for carrying out the invention (referred to as an “embodiment” hereafter) is described hereafter. It should be noted that the description is given in the following order.
1. Embodiment
2. Modified Example

### 1. Embodiment

### AV System Configuration

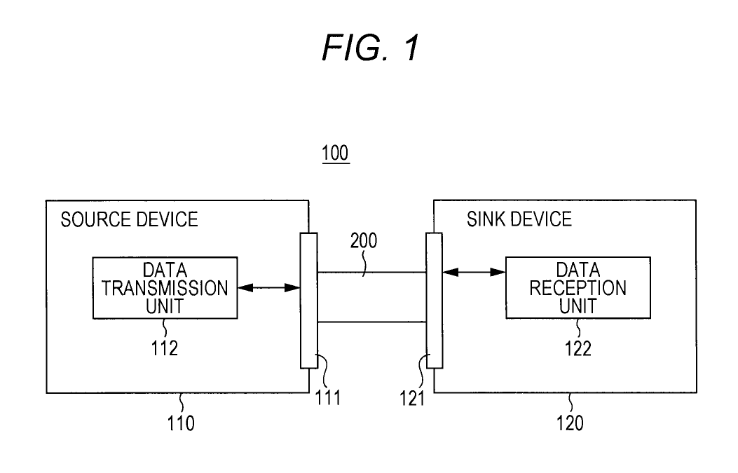

FIG. 1 shows an exemplary configuration of an audio and visual (AV) system 100. This AV system 100 is configured with a source device 110 and a sink device 120 being connected. The source device 110 is, for example, an AV source such as a game device, a disc player, a set-top box, a digital camera, or a mobile phone. The sink device 120 is, for example, a television receiver or a projector.

The source device 110 and the sink device 120 are connected via a cable 200. A connector unit 111 to which a data transmitting unit 112 is connected is provided in the source device 110. A connector unit 121 to which a data receiving unit 122 is connected is provided in the sink device 120. One end of the cable 200 is connected to the connector unit 111 of the source device 110, and the other end of this cable 200 is connected to the connector unit 121 of the sink device 120.

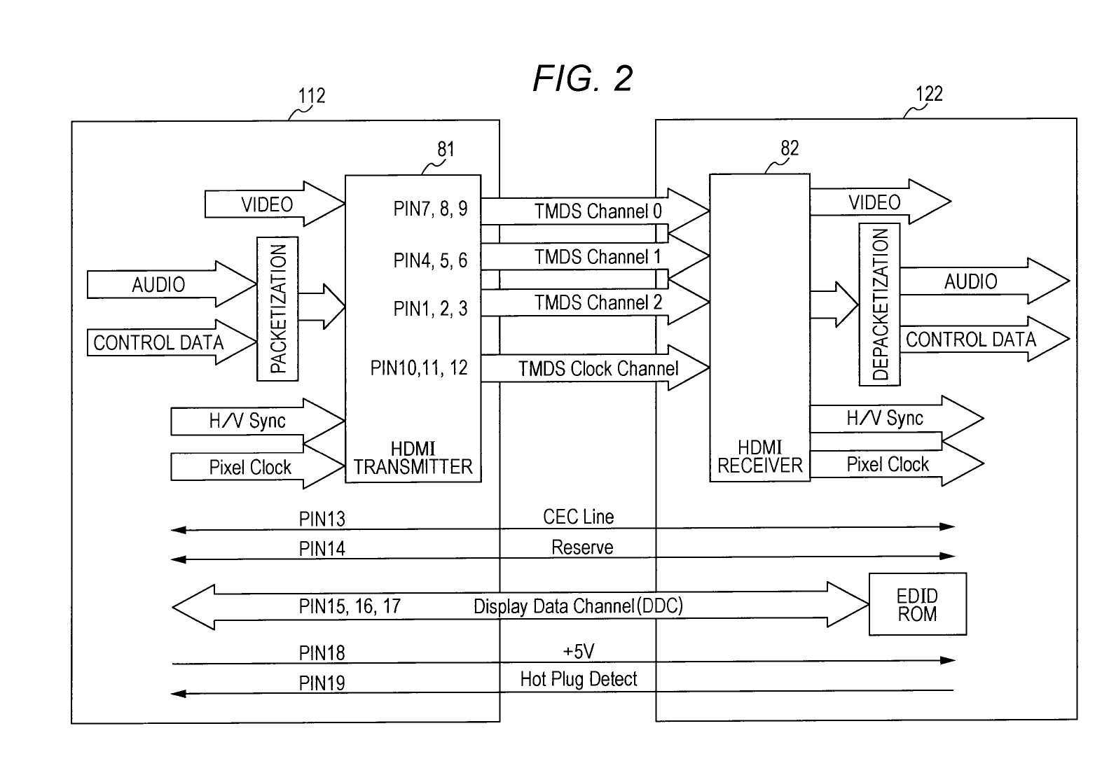

First, a description is given with respect to the case where the data transmitting unit 112 of the source device 110 and the data receiving unit 122 of the sink device 120 are compatible with an HDMI-specification digital interface. In this case, the cable 200 that connects the source device 110 and the sink device 120 is an HDMI cable. FIG. 2 shows an exemplary configuration of the data transmitting unit 112 of the source device 110, and the data receiving unit 122 of the sink device 120.

In an active video period, the data transmitting unit 112 unidirectionally transmits differential signals corresponding to pixel data of one screen portion of an uncompressed video to the data receiving unit 122 in a plurality of channels. Here, an active video period is a period obtained by excluding a horizontal retrace period and a vertical retrace period from the period from one vertical synchronizing signal to the next vertical synchronizing signal. Furthermore, in a horizontal retrace period or a vertical retrace period, the data transmitting unit 112 unidirectionally transmits differential signals corresponding to at least audio data and control data associated with a video and other auxiliary data and the like to the data receiving unit 122 in a plurality of channels.

The following transmission channels are included in the transmission channels of the HDMI system including the data transmitting unit 112 and the data receiving unit 122. Namely, there are three TMDS channels #0 to #2 that serve as transmission channels for serially transmitting pixel data and audio data in synchronization with a TMDS clock, in a unidirectional manner from the data transmitting unit 112 to the data receiving unit 122. Furthermore, there is a TMDS clock channel that serves as a transmission channel that transmits a TMDS clock from the data transmitting unit 112 to the data receiving unit 122.

The data transmitting unit 112 has an HDMI transmitter 81. This HDMI transmitter 81, for example, converts uncompressed video pixel data into corresponding differential signals, and in the three TMDS channels #0, #1, and #2 constituting a plurality of channels, serially transmits the differential signals in a unidirectional manner to the data receiving unit 122 connected via the HDMI cable. Furthermore, the HDMI transmitter 81 converts audio data associated with the uncompressed video, and also required control data and other auxiliary data and the like, into corresponding differential signals, and in the three TMDS channels #0, #1, and #2, serially transmits the differential signals in a unidirectional manner to the data receiving unit 122.

In addition, in the TMDS clock channel, the HDMI transmitter 81 transmits, to the data receiving unit 122 connected via the HDMI cable, a TMDS clock synchronized with the pixel data transmitted in the three TMDS channels #0, #1, and #2. Here, in one TMDS channel #1 (i=0, 1, 2), 10-bit pixel data is transmitted during one clock of the TMDS clock.

The data receiving unit 122 receives, in an active video period, in the plurality of channels, differential signals corresponding to the pixel data, unidirectionally transmitted from the data transmitting unit 112. Furthermore, this data receiving unit 122 receives, in a horizontal retrace period or a vertical retrace period, in the plurality of channels, differential signals corresponding to the audio data and the control data, unidirectionally transmitted from the data transmitting unit 112.

Namely, the data receiving unit 122 includes an HDMI receiver 82. This HDMI receiver 82 receives, in the TMDS channels #0, #1, and #2, the differential signals corresponding to the pixel data, and the differential signals corresponding to the audio data and the control data, unidirectionally transmitted from the data transmitting unit 112. In this case, the differential signals are received in synchronization with the TMDS clock transmitted from the data transmitting unit 112 in the TMDS clock channel.

Transmission channels referred to as Display Data Channel (DDC) and Consumer Electronics Control (CEC) lines are also included in the transmission channels of the HDMI system. The DDC includes two signal lines (not shown) included in the HDMI cable. The DDC is used by the data transmitting unit 112 for reading out Enhanced Extended Display Identification Data (E-EDID) from the data receiving unit 122.

In other words, the data receiving unit 122 has, apart from the HDMI receiver 81, EDID read only memory (ROM) that stores E-EDID constituting performance information relating to the performance (configuration/capability) of the data receiving unit 122. For example, in accordance with a request from a control unit (not shown), the data transmitting unit 112 reads out E-EDID, via the DDC, from the data receiving unit 122 connected via the HDMI cable.

The data transmitting unit 112 sends the read-out E-EDID to the control unit. The control unit stores this E-EDID in a flash ROM or DRAM (not shown). The control unit can recognize performance settings of the data receiving unit 122 on the basis of the E-EDID. For example, the control unit recognizes whether or not the sink device 120 including the data receiving unit 122 is able to handle stereoscopic image data, and in addition, if the sink device 120 is able to handle stereoscopic image data, which kind of TMDS transmission data structure the sink device 120 is compatible with, and the like.

The CEC line includes one signal line (not shown) included in the HDMI cable, and the CEC line is used for the bidirectional communication of data for control, between the data transmitting unit 112 and the data receiving unit 122. This CEC line constitutes a control data line.

Furthermore, a line (HPD line) that is referred to as a Hot Plug Detect (HPD) and is connected to a pin is included in the HDMI cable. The source device is able to use this HPD line to detect the connection of a sink device. Furthermore, a power line (+5 V power line) that is used to supply power from the source device to the sink device is included in the HDMI cable. In addition, a reserve line (reserve) is included in the HDMI cable.

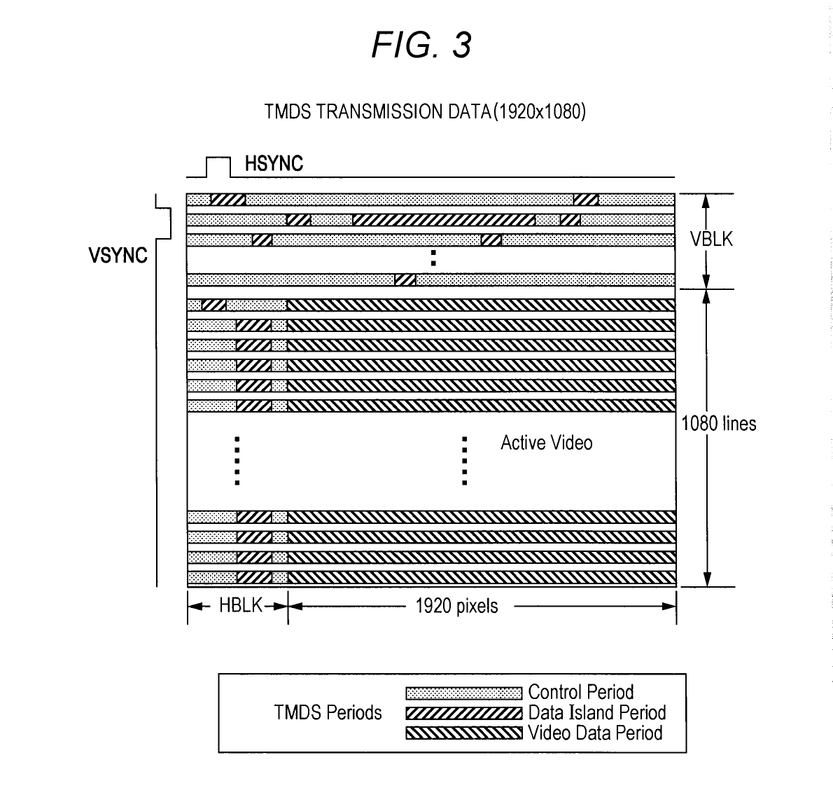

FIG. 3 shows an example of the structure of TMDS transmission data. This FIG. 3 shows periods for various types of transmission data in the case where video data of 1920 horizontal pixels×1080 vertical lines is transmitted in the TMDS channels #0, #1, and #2.

In accordance with the types of transmission data, there are three types of periods in a video field in which transmission data is transmitted in the three HDMI TMDS channels #0, #1, and #2. These three types of periods are a video data period, a data island period, and a control period.

Here, a video field period is a period from the rising edge (active edge) of a certain vertical synchronizing signal to the rising edge of the next vertical synchronizing signal. This video field period is divided into a horizontal blanking interval, a vertical blanking interval, and an active video interval. This active video period is a period obtained by excluding the horizontal blanking interval and the vertical blanking interval from a video field period.

Video data periods are allocated in active video periods. Data of the active pixels of a 1920 pixel×1080 line portion making up one screen portion of uncompressed video data is transmitted in these video data periods.

Data island periods and control periods are allocated in horizontal blanking intervals and vertical blanking intervals. Auxiliary data is transmitted in these data island periods and control periods. In other words, data island periods are allocated in a portion of the horizontal blanking intervals and vertical blanking intervals. For example, packets and the like of audio data, which is data that is not related to control from among the auxiliary data, are transmitted in these data island periods.

Control periods are allocated in other portions of the horizontal blanking intervals and the vertical blanking intervals. For example, a vertical synchronizing signal, a horizontal synchronizing signal, and a control packet and the like, which are data that is related to control from among the auxiliary data, are transmitted in these control periods.

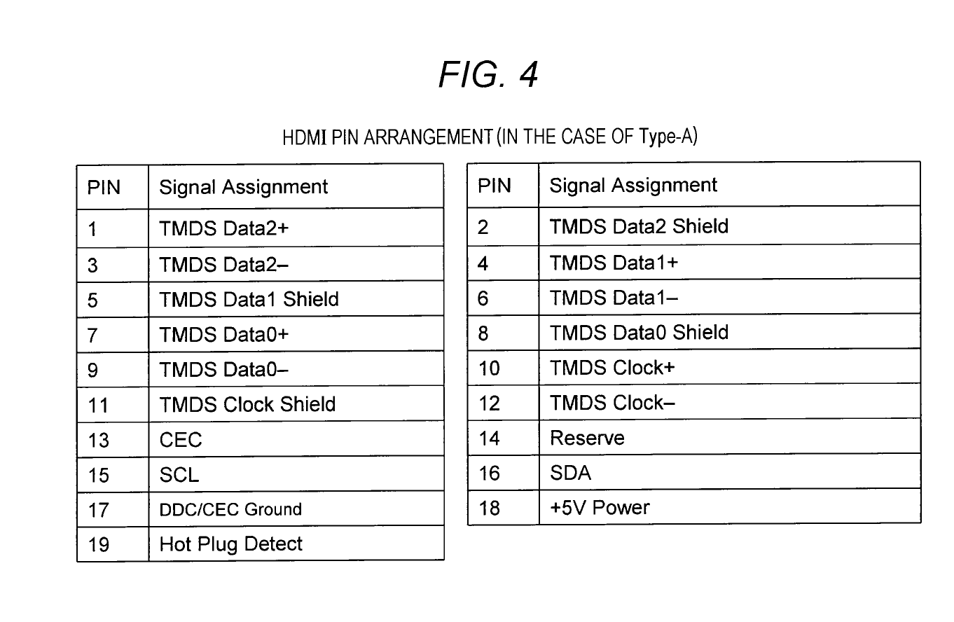

FIG. 4 is a diagram showing an example of the pin arrangement of an HDMI receptacle. The pin arrangement shown in FIG. 4 is referred to as type A. TMDS Data #i+ and TMDS Data #i−, which are differential signals of a TMDS channel #i, are transmitted by two differential lines. These two lines are connected to pins to which the TMDS Data #i+ is allocated (pins having pin numbers 1, 4, and 7), and to which the TMDS Data #i− is allocated (pins having pin numbers 3, 6, and 9).

Furthermore, a CEC line on which a CEC signal, which is data for control, is transmitted is connected to the pin having pin number 13. Furthermore, a line on which a (serial data (SDA) signal such as E-EDID is transmitted is connected to the pin having pin number 16. A line on which a (serial clock (SCL) signal, which is a clock signal that is used for synchronization when an SDA signal is transmitted and received, is transmitted is connected to the pin having pin number 15. The aforementioned DDC is constituted by the line on which an SDA signal is transmitted and the line on which an SCL signal is transmitted.

Furthermore, an HPD line for a source device to detect the connection of a sink device as mentioned above is connected to the pin having pin number 19. Furthermore, a reserve line is connected to the pin having pin number 14. Furthermore, a power line for supplying power as mentioned above is connected to the pin having pin number 18.

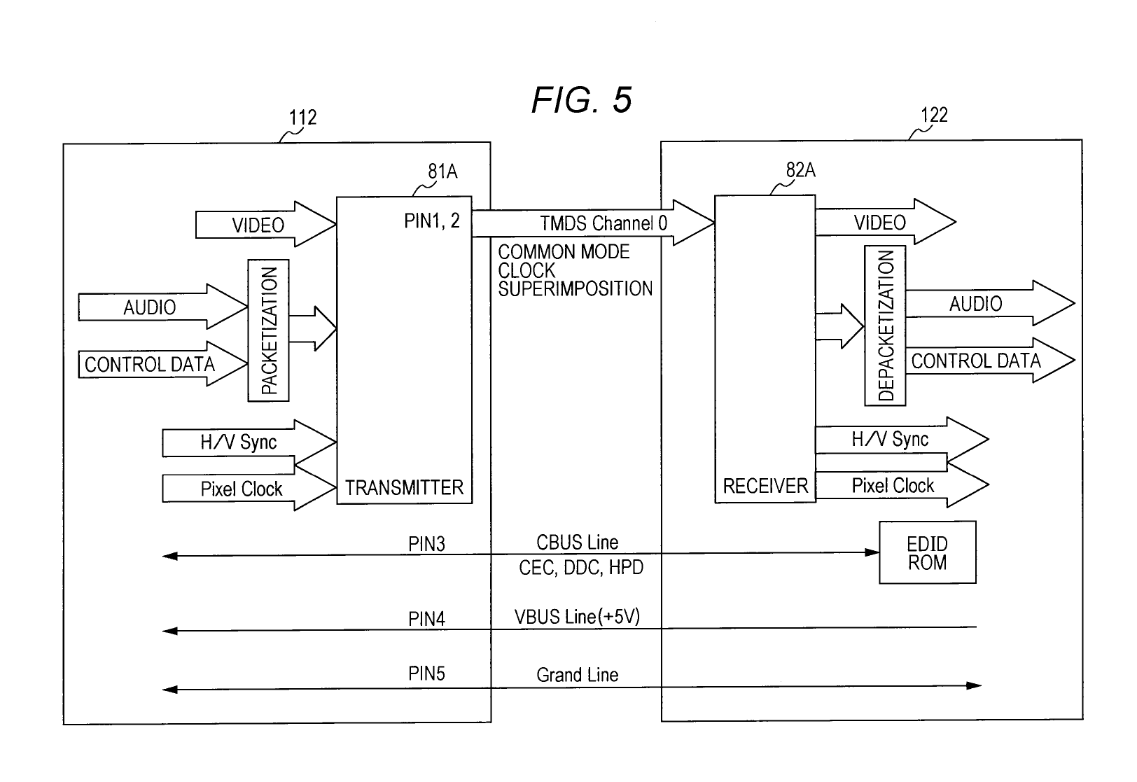

Next, a description is given with respect to the case where the data transmitting unit 112 of the source device 110 and the data receiving unit 122 of the sink device 120 are compatible with a new-specification digital interface. In this case, the cable 200 connecting the source device 110 and the sink device 120 is a new-specification cable. FIG. 5 shows an exemplary configuration of the data transmitting unit 112 of the source device 110, and the data receiving unit 122 of the sink device 120. In FIG. 5, the same reference signs are shown appended to the portions that correspond to FIG. 2, and a detailed description thereof is omitted as appropriate.

In an active video period, the data transmitting unit 112 unidirectionally transmits differential signals corresponding to pixel data of one screen portion of an uncompressed video to the data receiving unit 122 in one TMDS channel #0. Here, an active video period is a period obtained by excluding a horizontal retrace period and a vertical retrace period from the period from one vertical synchronizing signal to the next vertical synchronizing signal. Furthermore, in a horizontal retrace period or a vertical retrace period, the data transmitting unit 112 unidirectionally transmits differential signals corresponding to at least audio data and control data associated with a video, and other auxiliary data and the like, to the data receiving unit 122 in the same TMDS channel #0.

In this case, the internal clock is set to be three times greater than in the case of the HDMI specification (see FIG. 2), thereby enabling transmission using only the TMDS channel #0. Furthermore, the TMDS clock channel is also not required since the TMDS clock itself is superimposed in the TMDS channel #0 in a common mode. In the case of FIG. 5, the two pins of pins 1 and 2 of the transmission-side connector are used.

The data transmitting unit 112 includes a transmitter 81A. This transmitter 81A, for example, converts uncompressed video pixel data into corresponding differential signals, and in the one TMDS channel #0, serially transmits the differential signals in a unidirectional manner to the data receiving unit 122 that is connected via an HDMI cable or a new-specification cable. Furthermore, the transmitter 81A converts audio data associated with the uncompressed video, and also required control data and other auxiliary data and the like, into corresponding differential signals, and in the one TMDS channel #0, serially transmits the differential signals in a unidirectional manner to the data receiving unit 122.

The data receiving unit 122 receives, in an active video period, in the one TMDS channel #0, the differential signals corresponding to the pixel data, unidirectionally transmitted from the data transmitting unit 112. Furthermore, the data receiving unit 122 receives, in a horizontal retrace period and a vertical retrace period, in the one TMDS channel #0, the differential signals corresponding to the audio data and the control data, unidirectionally transmitted from the data transmitting unit 112. Namely, the data receiving unit 122 includes a receiver 82A. This receiver 82A receives, in the TMDS channel #0, the differential signals corresponding to the pixel data, and the differential signals corresponding to the audio data and control data, unidirectionally transmitted from the data transmitting unit 112.

Furthermore, one CBUS line is used as a CEC, a DDC, and an HPD line. Furthermore, the power line (+5 V power line) is omitted. Furthermore, a VBUS line is added for charging mobile source devices in the same way as a USB, and, in addition, a ground line (grand line) is commonly provided.

In the case of FIG. 5, the CBUS line is connected to the pin having pin number 3 in the transmission-side connector. Furthermore, the VBUS line is connected to the pin having pin number 4. In addition, the ground line is connected to the pin having pin number 5. Therefore, in this new-specification digital interface shown in FIG. 5, from among the 19 pins of the reception-side HDMI receptacle (A type), the remaining 14 pins are not used.

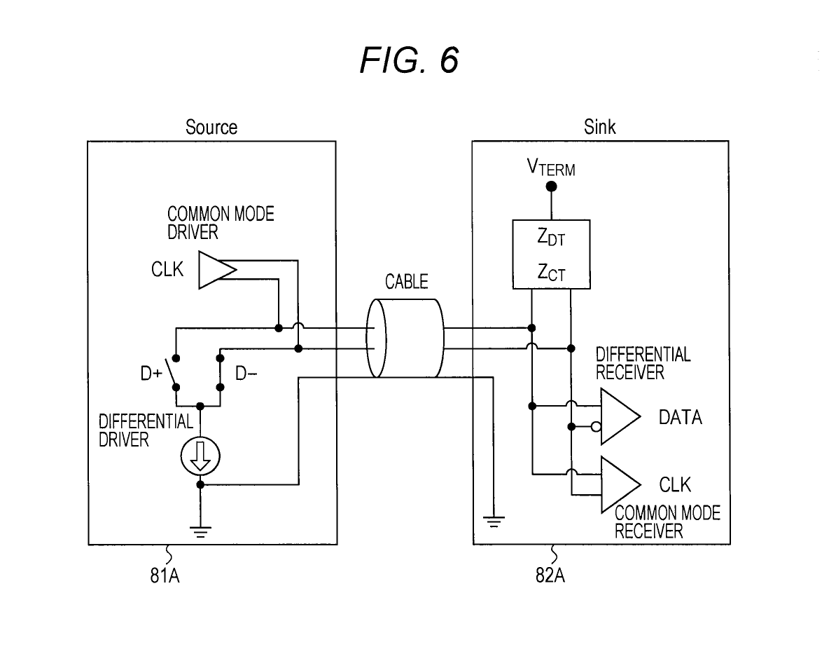

FIG. 6 shows an example of a driver configuration in the transmitter 81A, and a receiver configuration in the receiver 82A. In other words, a differential driver for the differential transmission (differential mode transmission) of data, and a common mode driver for the common mode transmission of the TMDS clock are provided in the transmitter 81A. Meanwhile, a differential receiver for the differential reception of data, and a common mode receiver for the common mode reception of the TMDS clock are provided in the receiver 82A.

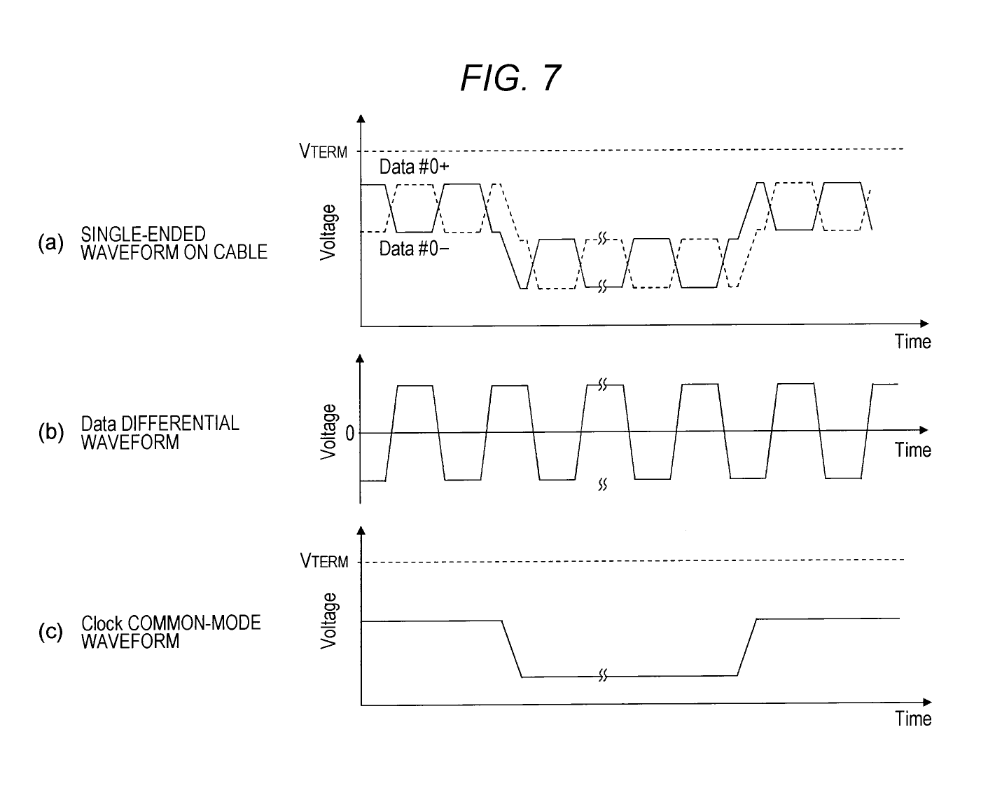

FIG. 7 (a) shows an example of a single-ended waveform on a cable. FIG. 7(b) shows an example of a data differential waveform received by the differential receiver of the receiver 82A, and FIG. 7(c) shows an example of a clock common-mode waveform received by the common mode receiver of the receiver 82A.

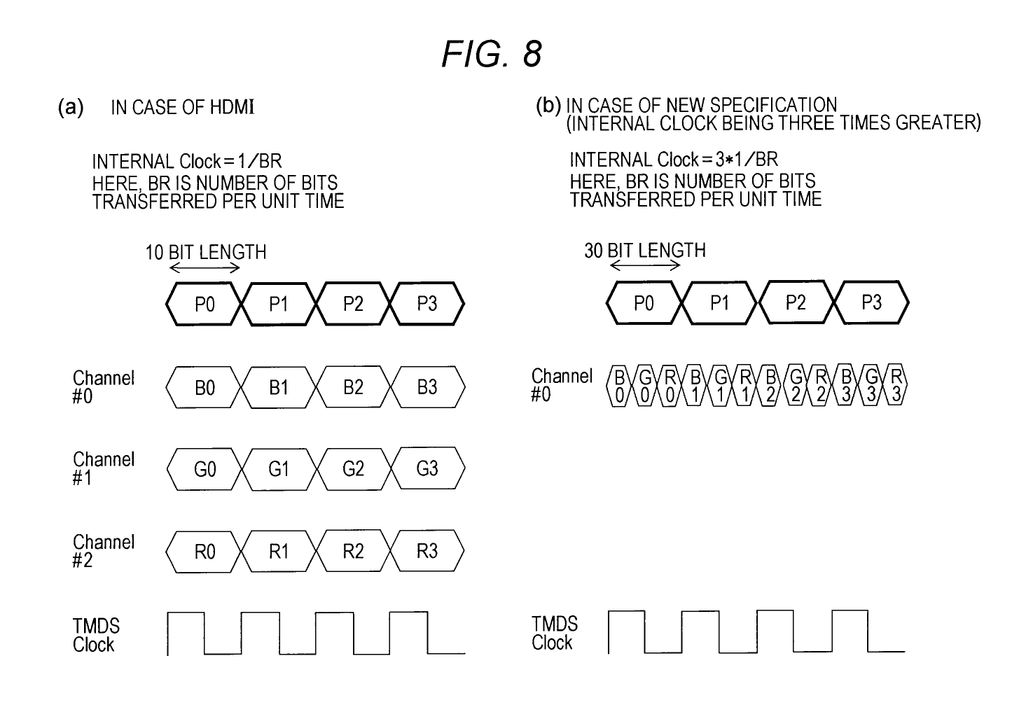

Furthermore, FIGS. 8 (a) and 8 (b) show the relationship between a TMDS clock and an internal clock. FIG. 8 (a) shows the case of HDMI. In the case of HDMI, blue color data is transmitted in channel #0, green color data is transmitted in channel #1, and red color data is transmitted in channel #2. In this case of HDMI, when the number of bits transferred per unit time is taken as BR, the relationship of the internal clock=1/BR is satisfied. FIG. 8(b) shows the case of the new specification (the internal clock being three times greater). In the case of the new specification, blue color data, green color data, and red color data are all transmitted in channel #0. In the case of this new specification, the relationship of the internal clock=3*1/BR is satisfied.

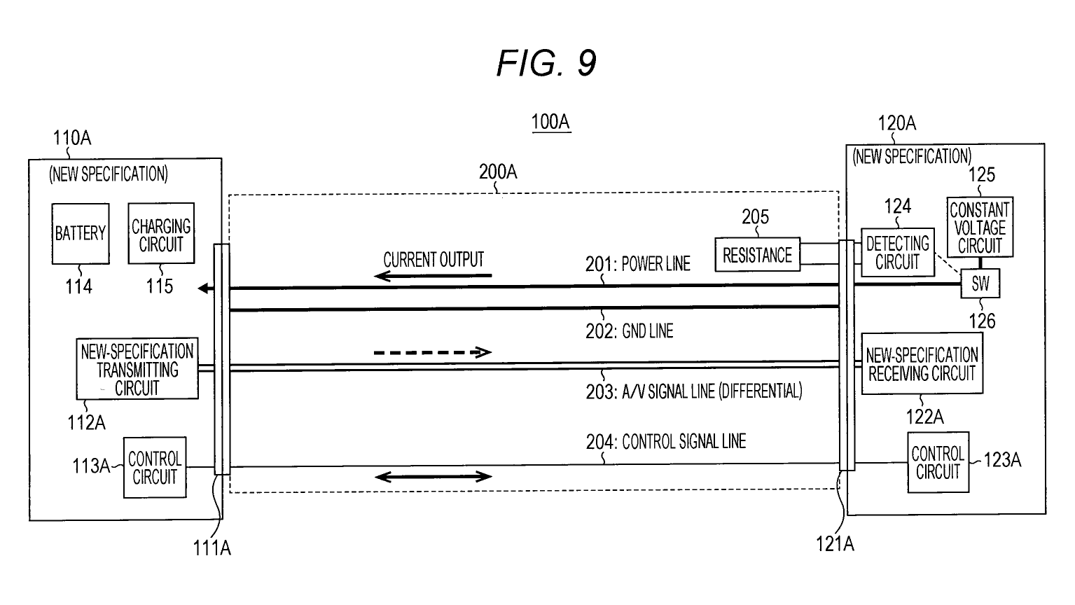

FIG. 9 shows an exemplary configuration of an AV system 100A. This AV system 100A is configured with a mobile phone 110A serving as a source device and a television receiver 120A serving as a sink device being connected. The mobile phone 110A and the television receiver 120A are compatible with the new specification, and are connected by a new-specification cable 200A.

The new-specification cable 200A is provided with, as signal lines, a power line 201, a ground (GND) line 202, an A/V signal line (differential) 203, and a control signal line 204. A plug having a configuration corresponding to a micro USB connector for example is provided at the source-side end of this new-specification cable 200A. Furthermore, a plug having a configuration corresponding to an HDMI connector (type A) for example is provided at the sink-side end of this new-specification cable 200A.

A resistance 205 for cable detection inserted between two specific pins is provided at the sink-side end of this new-specification cable 200A. A new specification-compatible sink device is able to recognize the connection of the new-specification cable 200A by detecting this resistance 205, and starts the supply of power to the power line 201 thereof.

The mobile phone 110A includes a new-specification transmitting circuit 112A, a control circuit 113A, a battery 114, and a charging circuit 115. The new-specification transmitting circuit 112A constitutes a data transmitting unit (see FIG. 5) that is compatible with the new-specification digital interface. The control circuit 113A controls the operation of the respective units of the mobile phone 110A. The new-specification transmitting circuit 112A and the control circuit 113A are connected to the connector unit 111A.

The television receiver 120A includes a new-specification receiving circuit 122A, a control circuit 123A, a detecting circuit 124, a constant voltage circuit 125, and a switch circuit 126. The new-specification receiving circuit 122A constitutes a data receiving unit (see FIG. 5) that is compatible with the new-specification digital interface. The control circuit 123A controls the operation of the units of the television receiver 120A. The new-specification receiving circuit 122A and the control circuit 123A are connected to a connector unit 121A.

The detecting circuit 124 detects the connection of the new-specification cable 200A by detecting the resistance 205 located in the new-specification cable 200A. The switch circuit 126, on the basis of the detection output of the detecting circuit 124, enters a connected state when the new-specification cable 200A is connected, and supplies power to the power line of the new-specification cable 200A, from the constant voltage circuit 125 via the connector unit 121A. Power is thereby supplied from the television receiver 120A to the mobile phone 110A via the new-specification cable 200A.

The control circuit 113A of the mobile phone 110A and the control circuit 123A of the television receiver 120A confirm whether the other party is a new specification-compatible device by detecting impedance via the control signal line of the new-specification cable 200A. After this confirmation, the transmission of video data and the like according to the new specification is performed from the new-specification transmitting circuit 112A of the mobile phone 110A to the new-specification receiving circuit 122A of the television receiver 120A.

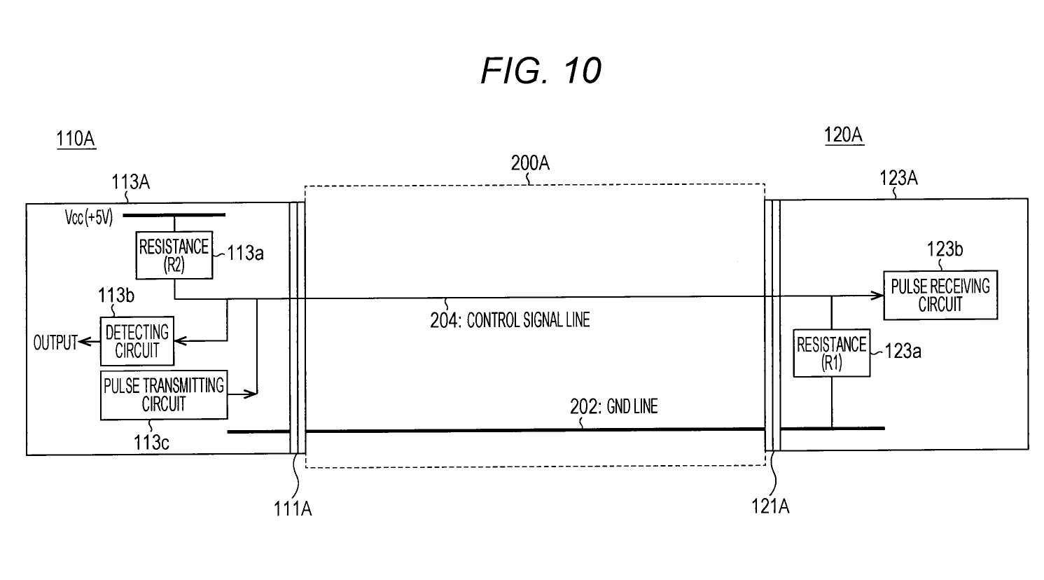

Here, the impedance detection procedure in the control circuits 113A and 123A is described with reference to FIG. 10. For example, the resistance value R1 of a pull-down resistance 123a inserted between the control signal line 204 and the ground line 202 in the control circuit 123A is set as 1 kΩ. Furthermore, for example, the resistance value R2 of a pull-up resistance 113a inserted between the control signal line 204 and the power source (Vcc=+5 V) in the control circuit 113A is set as 100 kΩ.

A detecting circuit 113b of the control circuit 113A monitors the voltage of the control signal line 204, and a high-level “H” is output if this voltage is higher than a reference voltage (Vref), and, contrastingly, a low-level “L” is output if this voltage is lower than the reference voltage (Vref). Here, Vref is set to a voltage higher than Vcc*R1/(R1+R2)=5 V*1/101=about 0.05 V, for example, 2.5 V.

Before the new-specification cable 200A is connected, the voltage of the control signal line 204 is approximately Vcc, and the output of the detecting circuit 113b is the high-level “H”. When the new-specification cable 200A is connected, the voltage of the control signal line 204 becomes the voltage divided by the resistances 113a and 123a (about 0.05 V), and the output of the detecting circuit 113b becomes the low-level “L”. The control circuit 113A of the mobile phone 110A is therefore able to detect that a new specification-compatible sink device is connected.

Next, a predetermined pulse train is transmitted from a pulse transmitting circuit 113c of the control circuit 113A. A pulse receiving circuit 123b of the control circuit 123A receives the pulse train sent from the control circuit 113A. The control circuit 123A of the television receiver 120A is therefore able to detect that a new specification-compatible source device is connected.

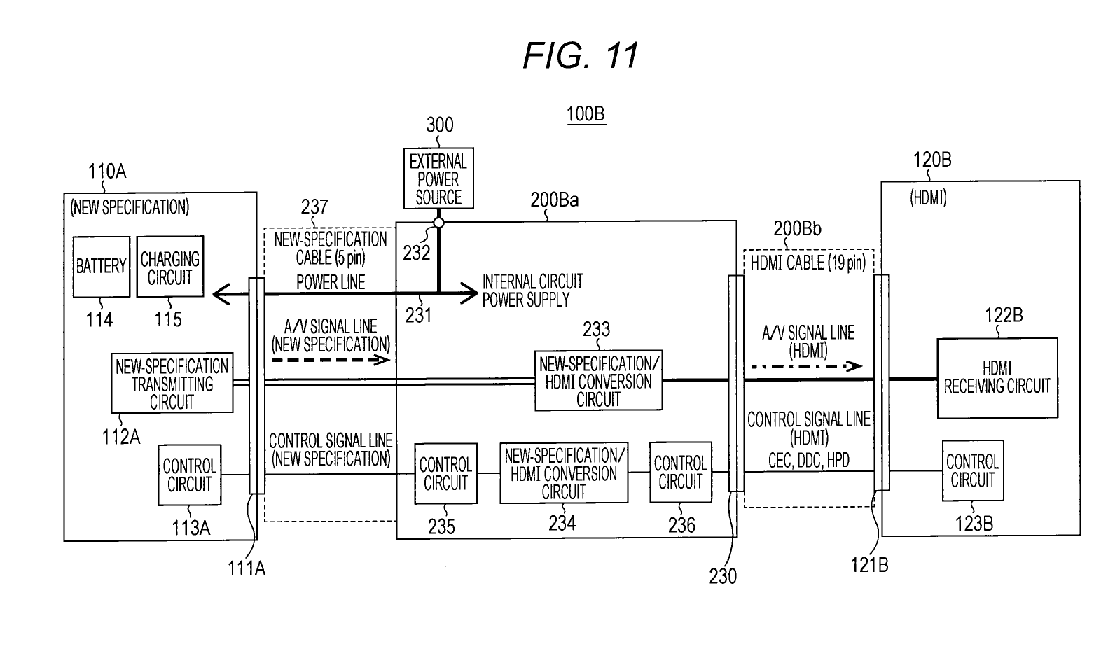

FIG. 11 shows an exemplary configuration of an AV system 100B. In this FIG. 11, the same reference signs are appended to the portions that correspond to FIG. 9, and a detailed description thereof is omitted as appropriate. This AV system 100B is configured with a mobile phone 110A serving as a source device and a television receiver 120B serving as a sink device being connected. The mobile phone 110A is compatible with the new specification, and the television receiver 120B is not compatible with the new specification but is compatible with HDMI. The mobile phone 110A and the television receiver 120B are connected by the series circuit of a dongle 200Ba serving as a signal conversion device, and an HDMI cable 200Bb.

The dongle 200Ba includes: a power line 231 for supplying power to an internal circuit and a source device, the mobile phone 110A in this case; and a power input unit 232 for supplying power from an external power source 300 such as AC adapter to this power line 231. Furthermore, this dongle 200Ba includes an A/V signal-related new-specification/HDMI conversion circuit 233, a control signal-related new-specification/HDMI conversion circuit 234, a source-side control circuit 235, and a sink-side control circuit 236.

The new-specification/HDMI conversion circuit 233 inputs a new-specification A/V signal (video data, audio data and control data associated therewith, and other auxiliary data and the like) that is transmitted on one pair of differential signal lines input thereto, performs conversion into HDMI A/V signals that are to be transmitted on three pairs of differential signal lines, and outputs the HDMI A/V signals. The new-specification/HDMI conversion circuit 234, combined with the control circuits 235 and 236, bidirectionally converts signals of the CEC, DDC, and HPD respective lines in HDMI and a signal of the CBUS line in the new specification.

The dongle 200Ba includes a new-specification cable 237 at the source side. A plug having a configuration corresponding to a micro USB connector for example is provided at a tip end of this new-specification cable 237. This plug is, in the connector unit 111A, connected to a receptacle of the mobile phone 110A. Connection of the dongle 200Ba and the mobile phone 110A is therefore achieved.

The aforementioned power line 231 is connected to a power line of this new-specification cable 237. Power from the external power source 300 is thereby supplied to the mobile phone 110A via the power line of the new-specification cable 237. Furthermore, the input side of the aforementioned new-specification/HDMI conversion circuit 233 is connected to an A/V signal line (new specification) of this new-specification cable 237. In addition, the aforementioned control circuit 235 is connected to a control signal line (CBUS line) of this new-specification cable 237.

Furthermore, the dongle 200Ba, at the sink side, is provided with a receptacle having a configuration corresponding to an HDMI connector (type A) for example. One of the plugs of the HDMI cable 200Bb is connected to this receptacle to constitute a connector unit 230. The output side of the aforementioned new-specification/HDMI conversion circuit 233 is connected to an A/V signal line (HDMI) of this HDMI cable 200Bb. Furthermore, the aforementioned control circuit 236 is connected to control signal lines (CEC, DDC, HPD respective lines) of this HDMI cable 200Bb.

The control circuit 235 of the dongle 200Ba is able to confirm that the other party, namely the mobile phone 110A, is a new specification-compatible device by detecting impedance via the control signal line of the new-specification cable 237. Furthermore, the circuit 236 of the dongle 200Ba is able to confirm that the HPD line becomes the high-level “H”, and that the other party, namely the television receiver 120B, is an HDMI-compatible device.

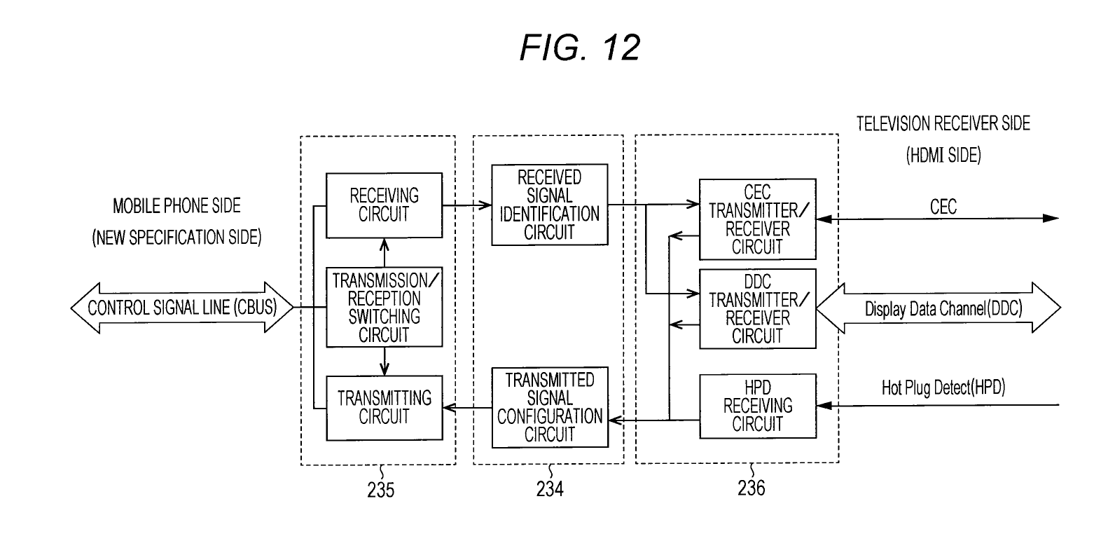

Here, the bidirectional conversion of CEC, DDC, and HPD line signals in HDMI and a CBUS line signal in the new specification by the new-specification/HDMI conversion circuit 234 and the control circuits 235 and 236 is described with reference to FIG. 12. It should be noted that only the portions of the control circuits 235 and 236 that relate to this bidirectional conversion are shown in this FIG. 12.

Since the control signal line (CBUS line) of the new specification side is one signal line, transmission/reception switching circuits of each of the control circuit 235 in the dongle 200Ba and the control circuit 113A in the mobile phone 110A perform communication, and one of these obtains the right to perform transmission. The transmitting circuit of the side that obtains the right to perform transmission transmits a signal (command) on the control signal line, and the receiving circuit of the opposing side receives this command.

If the receiving circuit of the control circuit 235 receives the signal, a received signal identification circuit of the new-specification/HDMI conversion circuit 234, in accordance with the category of the received signal, sends the signal to a CEC transmitter/receiver circuit or a DDC transmitter/receiver circuit of the control circuit 236, and transmits the signal to the HDMI side. Meanwhile, the control circuit 236 sends CEC, DDC, and HPD respective signals received by the CEC transmitter/receiver circuit, the DDC transmitter/receiver circuit, and an HPD receiving circuit from the HDMI side, to a transmitting circuit of the control circuit 235 through a transmitted signal configuration circuit of the new-specification/HDMI conversion circuit 234, and transmits the signals to the new specification side.

Returning to FIG. 11, the television receiver 120B includes an HDMI receiving circuit 122B and a control circuit 123B. The HDMI receiving circuit 122B constitutes a data receiving unit (see FIG. 2) compatible with the HDMI digital interface. The control circuit 123B controls the operation of the units of the television receiver 120B. The HDMI receiving circuit 122B and the control circuit 123B are connected to a connector unit 121B.

In the AV system 100B shown in FIG. 11, a new-specification A/V signal that is output from the new-specification transmitting circuit 112A of the mobile phone 110A is input to the new-specification/HDMI conversion circuit 233 via an A/V signal line in the new-specification cable 237 of the dongle 200Ba. In this new-specification/HDMI conversion circuit 233, the input new-specification A/V signal, namely an A/V signal transmitted on one pair of differential signal lines, is converted into HDMI A/V signals that are to be transmitted on three pairs of differential signal lines, and outputs the HDMI A/V signals. These HDMI A/V signals are received by the HDMI receiving circuit 122B of the television receiver 120B via the A/V signal line in the HDMI cable 200Bd.

In the AV system 100B shown in FIG. 11, the mobile phone 110A serving as a source device is compatible with the new specification, and the television receiver 120B serving as the sink device is compatible with HDMI. However, by using the dongle 200Ba that has a new-specification/HDMI conversion circuit, it becomes possible to transmit an A/V signal from the mobile phone 110A to the television receiver 120B.

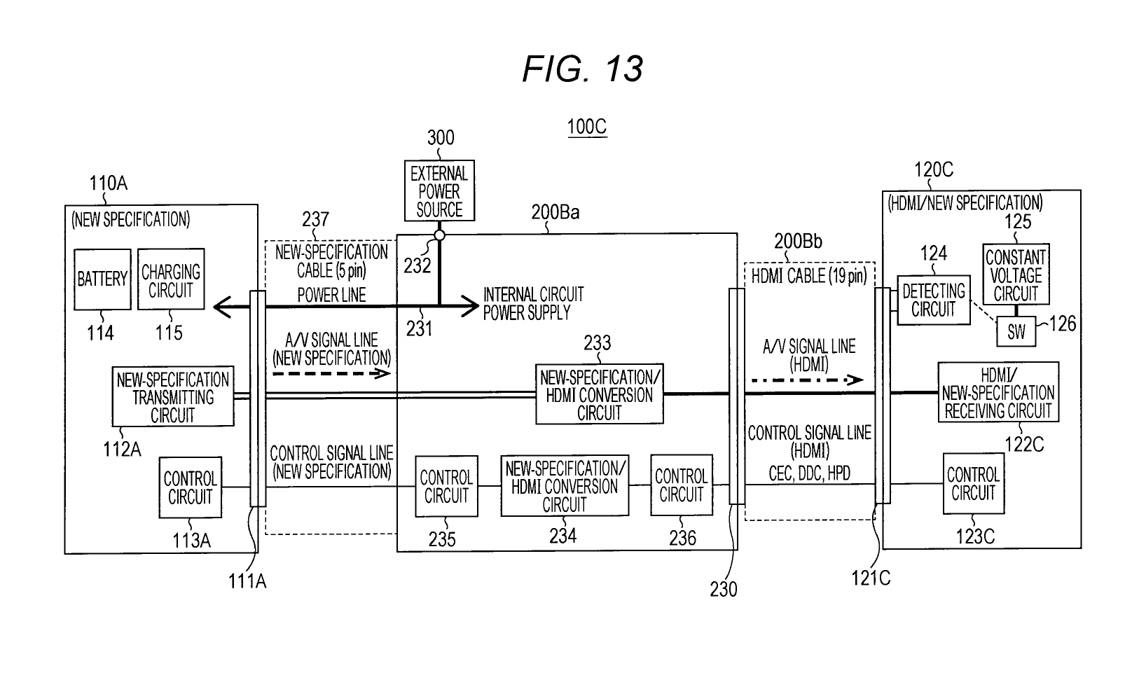

FIG. 13 shows an exemplary configuration of an AV system 100C. In this FIG. 13, the same reference signs are appended to the portions that correspond to FIG. 11, and a detailed description thereof is omitted as appropriate. This AV system 100C is configured with a mobile phone 110A serving as a source device and a television receiver 120C serving as a sink device being connected. The mobile phone 110A is compatible with the new specification, and the television receiver 120C is compatible with both the new specification and HDMI. The mobile phone 110A and the television receiver 120C are connected by the series circuit of a dongle 200Ba serving as a signal conversion device, and an HDMI cable 200Bb.

The television receiver 120C includes an HDMI/new-specification receiving circuit 122C, a control circuit 123C, a detecting circuit 124, a constant voltage circuit 125, and a switch circuit 126. The HDMI/new-specification receiving circuit 122C constitutes a data receiving unit (see FIG. 2 and FIG. 5) that is compatible with both the HDMI and new specification digital interfaces. The control circuit 123C controls the operation of the respective units of the television receiver 120C. The HDMI/new-specification receiving circuit 122C and the control circuit 123C are connected to a connector unit 121C.

The detecting circuit 124 detects the connection of a new-specification cable by detecting a resistance located in the new-specification cable (see FIG. 9). The switch circuit 126, on the basis of the detection output of the detecting circuit 124, enters a connected state when the new-specification cable is connected, and supplies power to the power line of the new-specification cable, from the constant voltage circuit 125 via the connector unit 121C. Power can therefore be supplied from the television receiver 120C to the mobile phone 110A via the new-specification cable.

In the case of the AV system 100C shown in FIG. 13, since the dongle 200Ba is provided between the mobile phone 110A and the television receiver 120C, the HDMI/new-specification receiving circuit 122C of the television receiver 120C operates in an HDMI mode. In other words, operation in this case is the same as in the AV system 100B of FIG. 11.

As mentioned above, the mobile phone 110A is compatible with the new specification, and the television receiver 120C is compatible with both the new specification and HDMI. Therefore, if these are connected by a new-specification cable, the HDMI/new-specification receiving circuit 122C of the television receiver 1200 can be operated in a new specification mode, and the mobile phone 110A and the television receiver 120C can be connected by using the new-specification digital interface. Moreover, power can be supplied from the television receiver 120C to the mobile phone 110A. However, due to the dongle 200Ba being provided between the mobile phone 110A and the television receiver 120C as mentioned above, the functions specific to the new specification cannot be used.

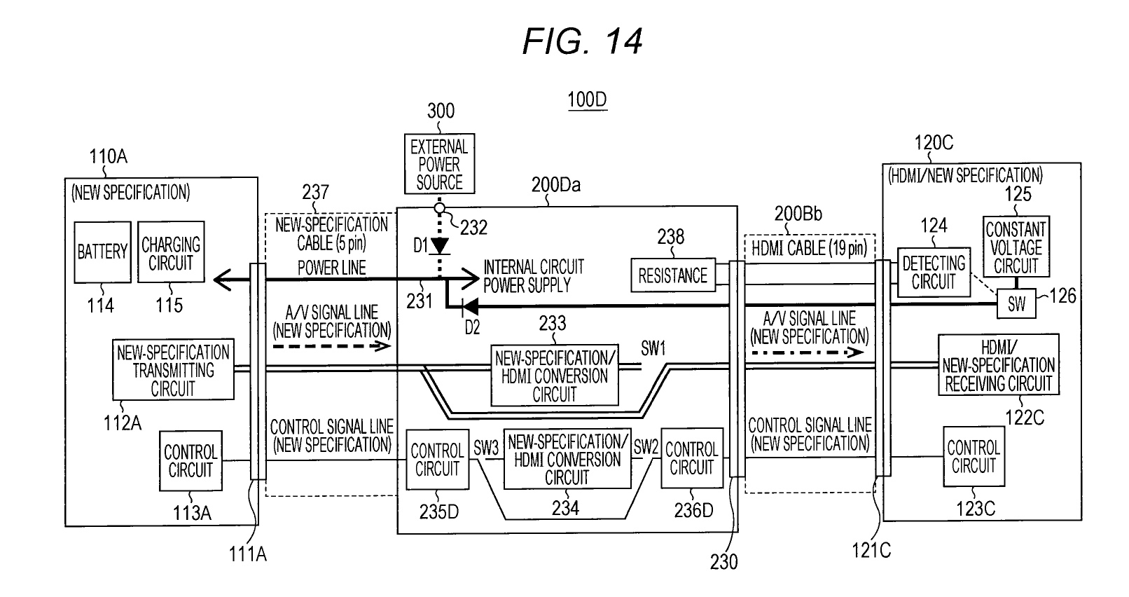

FIG. 14 shows an exemplary configuration of an AV system 100D serving as an embodiment. In this FIG. 14, the same reference signs are appended to the portions that correspond to FIG. 13, and a detailed description thereof is omitted as appropriate. This AV system 100D is configured with a mobile phone 110A serving as a source device and a television receiver 120C serving as a sink device being connected. The mobile phone 110A is compatible with the new specification, and the television receiver 120C is compatible with both the new specification and HDMI. The mobile phone 110A and the television receiver 120C are connected by the series circuit of a dongle 200Da serving as a signal conversion device, and an HDMI cable 200Bb.

The mobile phone 110A includes a new-specification transmitting circuit 112A, a control circuit 113A, a battery 114, and a charging circuit 115. The new-specification transmitting circuit 112A constitutes a data transmitting unit (see FIG. 5) that is compatible with the new-specification digital interface. The control circuit 113A controls the operation of the respective units of the mobile phone 111A. The new-specification transmitting circuit 112A and the control circuit 113A are connected to the connector unit 111A.

The television receiver 120C includes an HDMI/new-specification receiving circuit 122C, a control circuit 123C, a detecting circuit 124, a constant voltage circuit 125, and a switch circuit 126. The HDMI/new-specification receiving circuit 122C constitutes a data receiving unit (see FIG. 2 and FIG. 5) that is compatible with both the HDMI and new specification digital interfaces. The control circuit 123C controls the operation of the respective units of the television receiver 120C. The HDMI/new-specification receiving circuit 122C and the control circuit 123C are connected to a connector unit 121C.

The detecting circuit 124 detects whether or not a resistance is inserted between two specific pins of the HDMI receptacle. For example, when the new-specification cable is connected to the HDMI receptacle, the detecting circuit 124 detects the resistance provided in that new-specification cable (see FIG. 9). In this embodiment, since the dongle 200Da is connected to the HDMI receptacle via the HDMI cable 200Bd, the detecting circuit 124 detects a resistance 238 provided in that dongle 200Da.

The switch circuit 126, on the basis of the detection output of the detecting circuit 124, enters a connected state when a resistance is inserted, and supplies power to the device in which the resistance is located, from the constant voltage circuit 125 via the connector unit 121C. In this embodiment, since the dongle 200Da is connected to the HDMI receptacle via the HDMI cable 200Bd, power is supplied to the power line of the dongle 200Da from the constant voltage circuit 125 via the HDMI cable 200Bd.

The dongle 200Da includes: a power line 231 for supplying power to an internal circuit and a source device, the mobile phone 110A in this case; and a power input unit 232 for supplying power from an external power source 300 such as AC adapter to this power line 231. Furthermore, this dongle 200Da includes an A/V signal-related new-specification/HDMI conversion circuit 233, a control signal-related new-specification/HDMI conversion circuit 234, a source-side control circuit 235D, and a sink-side control circuit 236D.

The new-specification/HDMI conversion circuit 233 inputs a new-specification A/V signal (video data, audio data and control data associated therewith, and other auxiliary data and the like) that is transmitted on one pair of differential signal lines input thereto, performs conversion into HDMI A/V signals that are to be transmitted on three pairs of differential signal lines, and outputs the HDMI A/V signals. The new-specification/HDMI conversion circuit 234, combined with the control circuits 235D and 236D, bidirectionally converts signals of the CEC, DDC, and HPD lines in HDMI and a signal of the CBUS line in the new specification.

The dongle 200Da includes a new-specification cable 237 at the source side. A plug having a configuration corresponding to a micro USE connector for example is provided at a tip end of this new-specification cable 237. This plug is, in the connector unit 111A, connected to a receptacle of the mobile phone 110A. Connection of the dongle 200Da and the mobile phone 110A is therefore achieved.

The aforementioned power line 231 is connected to a power line of this new-specification cable 237. Power from the television receiver 120C or the external power source 300 is thereby supplied to the mobile phone 110A via the power line of the new-specification cable 237. Furthermore, the input side of the aforementioned new-specification/HDMI conversion circuit 233 is connected to an A/V signal line (new specification) of this new-specification cable 237. In addition, the aforementioned control circuit 235D is connected to a control signal line (CBUS line) of this new-specification cable 237.

Furthermore, the dongle 200Da, at the sink side, is provided with a receptacle having a configuration corresponding to an HDMI connector (type A) for example. One of the plugs of the HDMI cable 200Bb is connected to this receptacle to constitute a connector unit 230.

The output side of the aforementioned new-specification/HDMI conversion circuit 233, or the A/V signal line (new specification) of the aforementioned new-specification cable 237, is selectively connected to an A/V signal line of the HDMI cable 200Bb by a switch circuit SW1. When the output side of the new-specification/HDMI conversion circuit 233 is selected, the A/V signal line (HDMI) of the HDMI cable 200Bb is constituted by three pairs of differential signal lines. On the other hand, when the A/V signal line (new specification) of the new-specification cable 237 is selected, the A/V signal line (new specification) of the HDMI cable 200Bb is constituted by one pair of differential signal lines.

Furthermore, the aforementioned control circuit 236D is connected to a control signal line of this HDMI cable 200Bb. When the aforementioned switch circuit SW1 selects the output side of the new-specification/HDMI conversion circuit 233, the control circuit 236D is connected to the HDMI control signal lines (CEC, DDC, HPD respective lines) of the HDMI cable 200Bb. On the other hand, when the aforementioned switch circuit SW1 selects the A/V signal line (new specification) of the new-specification cable 237, the control circuit 236D is connected to the new-specification control signal line (CBUS line).

Furthermore, the dongle 200Da includes a switch circuit SW3 between the control circuit 235D and the new-specification/HDMI conversion circuit 234, and also includes a switch circuit SW2 between the new-specification/HDMI conversion circuit 234 and the control circuit 236D. The control circuit 236D, as mentioned hereafter, controls the switching operations performed by the switch circuits SW2 and SW3, and also the switching operation performed by the switch circuit SW1.

When the aforementioned switch circuit SW1 selects the output side of the new-specification/HDMI conversion circuit 233, the switch circuits SW2 and SW3 connect the control circuits 235D and 236D to the new-specification/HDMI conversion circuit 234. A state is thereby entered in which signals of the CEC, DDC, and HPD respective lines in HDMI and a signal of the CBUS line in the new specification are bidirectionally converted. On the other hand, when the aforementioned switch circuit SW1 selects the A/V signal line (new specification) of the new-specification cable 237, the switch circuits SW2 and SW3 directly connect the control circuits 235D and 236D. A state is thereby entered in which only the signal of the CBUS line in the new specification is bidirectionally transmitted.

The bidirectional conversion by the new-specification/HDMI conversion circuit 234 and the control circuits 235D and 236D is the same as the bidirectional conversion by the new-specification/HDMI conversion circuit 234 and the control circuits 235 and 236 in the dongle 200Ba of the AV system 100B in FIG. 11 (see FIG. 12). Moreover, although not shown, if the control circuits 235D and 236D are directly connected, a state is entered in which the control signal line (CBUS line) of the new-specification cable 237 is directly connected to the control signal line (CBUS line) of the HDMI cable 200Bb.

Furthermore, the dongle 200Da includes a resistance 238 for prompting a new specification-compatible sink device to supply power. This resistance 238 is inserted between two specific pins of the HDMI receptacle. As mentioned above, by detecting this resistance 238, the television receiver 120C starts the supply of power to the dongle 200Da via the HDMI cable 200Bb.

Furthermore, the dongle 200Da includes a power interference prevention unit that prevents interference between power input from the external power source 300, and power input from a new specification-compatible sink device, the television receiver 120C in this embodiment. This power interference prevention unit is constituted by a diode bridge including diodes D1 and D2. The diode D1 is inserted into a power supply path from the power input unit 232 to the power line 231. Furthermore, the diode D2 is inserted in a power supply path from the sink device (television receiver 120C) to the power line 231.

Moreover, for example, it is thought that the power interference prevention unit can be configured using a switch circuit that disconnects the power supply path from the power input unit 232 to the power line 231 when the supply of power from the sink device (television receiver 120C) to the power line 231 starts.

The control circuit 113A of the mobile phone 110A and the control circuit 235D of the dongle 200Da confirm whether the other party is a new specification-compatible device by detecting impedance via the control signal line of the new-specification cable 237. After this confirmation, it becomes possible to perform command communication in both directions on the control signal line (CBUS line), between the control circuit 113A and the control circuit 235D.

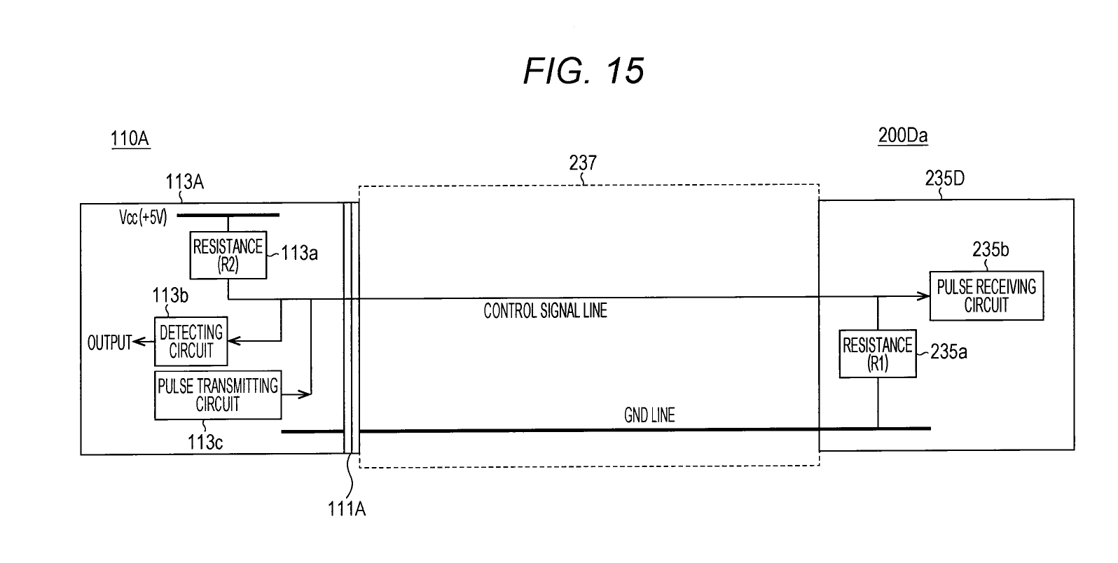

Here, the impedance detection procedure in the control circuits 113A and 235D is described with reference to FIG. 15. For example, the resistance value R1 of a pull-down resistance 235a inserted between the control signal line and the ground line (GND line) in the control circuit 235D is set as 1 kΩ. Furthermore, for example, the resistance value R2 of a pull-up resistance 113a inserted between the control signal line and the power source (Vcc=+5 V) in the control circuit 113A is set as 100 kΩ.

The detecting circuit 113b of the control circuit 113A monitors the voltage of the control signal line, and a high-level “H” is output if this voltage is higher than a reference voltage (Vref), and, contrastingly, a low-level “L” is output if this voltage is lower than the reference voltage (Vref). Here, Vref is set to a voltage higher than Vcc*R1/(R1+R2)=5 V*1/101=about 0.05 V, for example, 2.5 V.

Before the new-specification cable 237 (dongle 200Da) is connected, the voltage of the control signal line is approximately Vcc, and the output of the detecting circuit 113b is the high-level “H”. When the new-specification cable 237 (dongle 200Da) is connected, the voltage of the control signal line 204 becomes the voltage divided by the resistances 113a and 123a (about 0.05V), and the output of the detecting circuit 113b becomes the high-level “L”. The control circuit 113A of the mobile phone 110A is therefore able to detect that the new specification-compatible dongle 200Da is connected.

Next, a predetermined pulse train is transmitted from a pulse transmitting circuit 113c of the control circuit 113A. A pulse receiving circuit 235b of the control circuit 235D receives the pulse train sent from the control circuit 113A. The control circuit 235D of the dongle 200Da is therefore able to detect that a new specification-compatible sink device, the mobile phone 110A in this embodiment, is connected.

Returning to FIG. 14, the control circuit 236D of the dongle 200Da determines, by the following procedure, whether the sink device, the television receiver 120C in this embodiment, is new-specification compatible or is new-specification incompatible (HDMI compatible), and controls the switching operations performed by the switch circuits SW1, SW2, and SW3. First, the control circuit 236D confirms that the HPD line is the high-level “H”, and confirms that the television receiver 120C is an HDMI-compatible device.

Next, the control circuit 236D confirms that the television receiver 120C is a new specification-compatible device by detecting impedance. Although a detailed description is omitted, the procedure for this impedance detection is the same as the procedure for the detection of impedance in the control circuit 113A of the mobile phone 110A and the control circuit 123A of the television receiver 120A in the AV system 100A shown in FIG. 9 (see FIG. 10).

When the control circuit 236D of the dongle 200Da determines that the sink device is new-specification compatible, controls the switch circuits SW1, SW2, and SW3 as follows. That is, with respect to the switch circuit SW1, control is performed in such a way that the A/V signal line (new specification) of the new-specification cable 237 is selected. Furthermore, with respect to the switch circuits SW2 and SW3, control is performed in such a way that the control circuits 235D and 236D are directly connected.

On the other hand, when the control circuit 236D of the dongle 200Da determines that the sink device is new-specification incompatible (HDMI compatible), controls the switch circuits SW1, SW2, and SW3 as follows. In other words, with respect to the switch circuit SW1, control is performed in such a way that the output side of the new-specification/HDMI conversion circuit 233 is selected. Furthermore, with respect to the switch circuits SW2 and SW3, control is performed in such a way that the control circuits 235D and 236D are connected to the new-specification/HDMI conversion circuit 234.

The operation of the AV system 100D shown in FIG. 14 is described. When the dongle 200Da is connected to the mobile phone 110A by the new-specification cable 237, the control circuit 113A of the mobile phone 110A and the control circuit 235D of the dongle 200Da confirm whether the other party is a new specification-compatible device by detecting impedance. After this confirmation, it becomes possible to perform command communication in both directions on the control signal line (CBUS line), between the control circuit 113A and the control circuit 235D.

Furthermore, when the television receiver 120C is connected to the dongle 200Da by the HDMI cable 200Bb, the television receiver 120C detects the resistance 238 of the dongle 200Da. The television receiver 120C sets the switch circuit 126 to a connected state on the basis of the detection output of the detecting circuit 124, and starts the supply of power from the constant voltage circuit 125 to the dongle 200Da via the HDMI cable 200Bb. Furthermore, until power from the television receiver 120C is supplied in this way, the dongle 200Da operates by the power supplied from the external power source 300.

Furthermore, when the television receiver 120C is connected to the dongle 200Da by the HDMI cable 200Bb, the control circuit 236D of the dongle 200Da and the control circuit 1230 of the television receiver 1200 confirm whether the other party is a new specification-compatible device by detecting impedance. After this confirmation, the HDMI/new-specification receiving circuit 122C of the television receiver 120C switches modes so as to operate as a new-specification receiving circuit. Furthermore, after this confirmation, it becomes possible to perform command communication in both directions on the control signal line (CBUS line), between the control circuit 236D and the control circuit 123C.

Furthermore, after the aforementioned confirmation, the switch circuits SW1, SW2, and SW3 are controlled as follows by the control circuit 236D. In other words, as shown, the switch circuit SW1 is controlled in such a way that the A/V signal line (new specification) of the new-specification cable 237 is selected. Furthermore, as shown, the switch circuits SW2 and SW3 are controlled in such a way that the control circuits 235D and 236D are directly connected.

In the aforementioned state, a new-specification A/V signal (video data, audio data and control data associated therewith, and other auxiliary data and the like) output from the new-specification transmitting circuit 112A of the mobile phone 110A passes through the dongle 200Da in that state. This A/V signal is then received by the HDMI/new-specification receiving circuit 122C of the television receiver 120C via the A/V signal line (new specification) of the HDMI cable 200Bb.

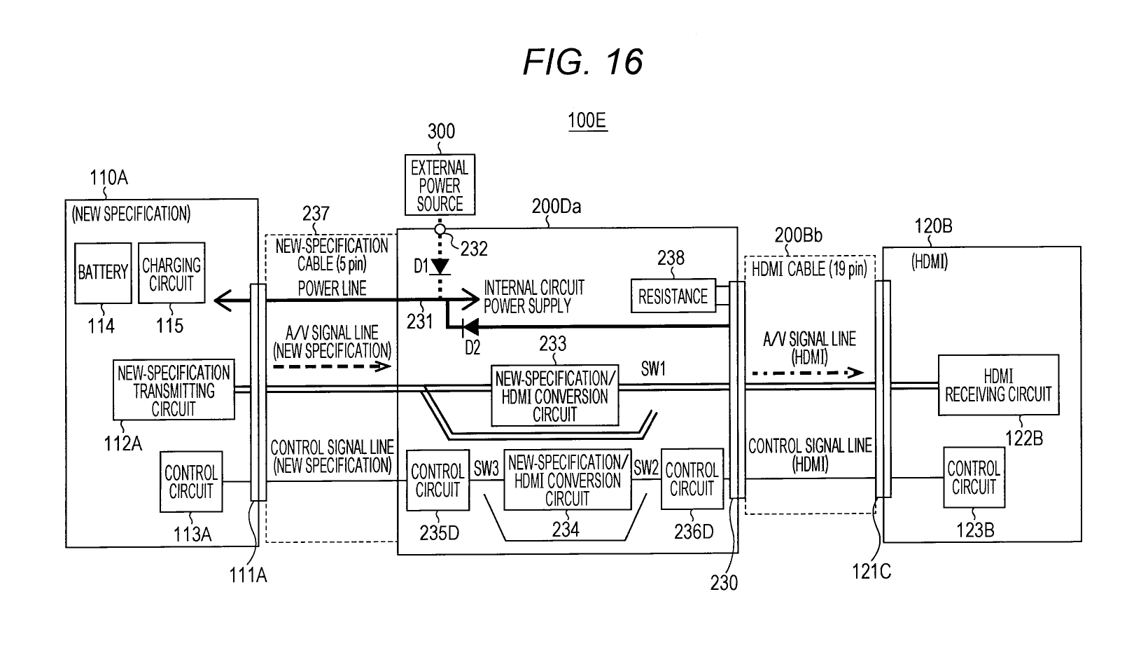

FIG. 16 shows an AV system 100E in which a new specification-incompatible (HDMI compatible) television receiver 120B is connected instead of the television receiver 120C in the AV system 100D of FIG. 14. In the case of this AV system 100E, when the television receiver 120B is connected to the dongle 200Da by the HDMI cable 2006b, the control circuit 236D of the dongle 200Da confirms that the other party is a new specification-incompatible device by detecting impedance.

After this confirmation, the switch circuits SW1, SW2, and SW3 are controlled as follows by the control circuit 236D. In other words, as shown, the switch circuit SW1 is controlled in such a way that the output side of the new-specification/HDMI conversion circuit 233 is selected. Furthermore, the switch circuits SW2 and SW3 are controlled in such a way that the control circuits 235D and 236D are connected to the new-specification/HDMI conversion circuit 234.

In the aforementioned state, a new-specification A/V signal (video data, audio data and control data associated therewith, and other auxiliary data and the like) output from the new-specification transmitting circuit 112A of the mobile phone 110A is input to the new-specification/HDMI conversion circuit 233 of the dongle 200Da. In this new-specification/HDMI conversion circuit 233, the input new-specification A/V signal, namely an A/V signal transmitted on one pair of differential signal lines, is converted into HDMI A/V signals that are to be transmitted on three pairs of differential signal lines, and outputs the HDMI A/V signals. These HDMI A/V signals are received by the HDMI receiving circuit 122B of the television receiver 120B via the A/V signal line (HDMI) in the HDMI cable 200Bd.

As mentioned above, in the present embodiment, when the new specification-compatible television receiver 120C is connected, the dongle 200Da enters a state in which signal conversion is not performed. A state is entered in which the mobile phone 110A and the television receiver 120C are directly connected by the new specification, and functions specific to the new specification can be used. Therefore, it is possible to achieve an improvement in user convenience.

Furthermore, in the present embodiment, the dongle 200Da includes a resistance 238 for prompting a new specification-compatible sink device to supply power. Therefore, when the new specification-compatible television receiver 120C is connected, it is possible to receive a supply of power from this television receiver 120C. Consequently, operation becomes possible without receiving power supply from an external power source such as an AC adapter.

Furthermore, in the present embodiment, the dongle 200Da has a power interference prevention unit that prevents interference between power input from an external power source 300, and power input from a new specification-compatible sink device (television receiver 120C). Therefore, it becomes possible to supply power in a satisfactory manner also from the external power source 300 such as an AC adapter.

### 2. Modified Example

In addition, in the aforementioned embodiment, it is thought that a configuration is also possible in which the dongle 200Da, although being able to receive power supply from the external power source 300 or the sink device (television receiver 120C), also receives power from a source device. This would be effective in a state in which the external power source 300 is not connected and, furthermore, power supply from the sink device is started.

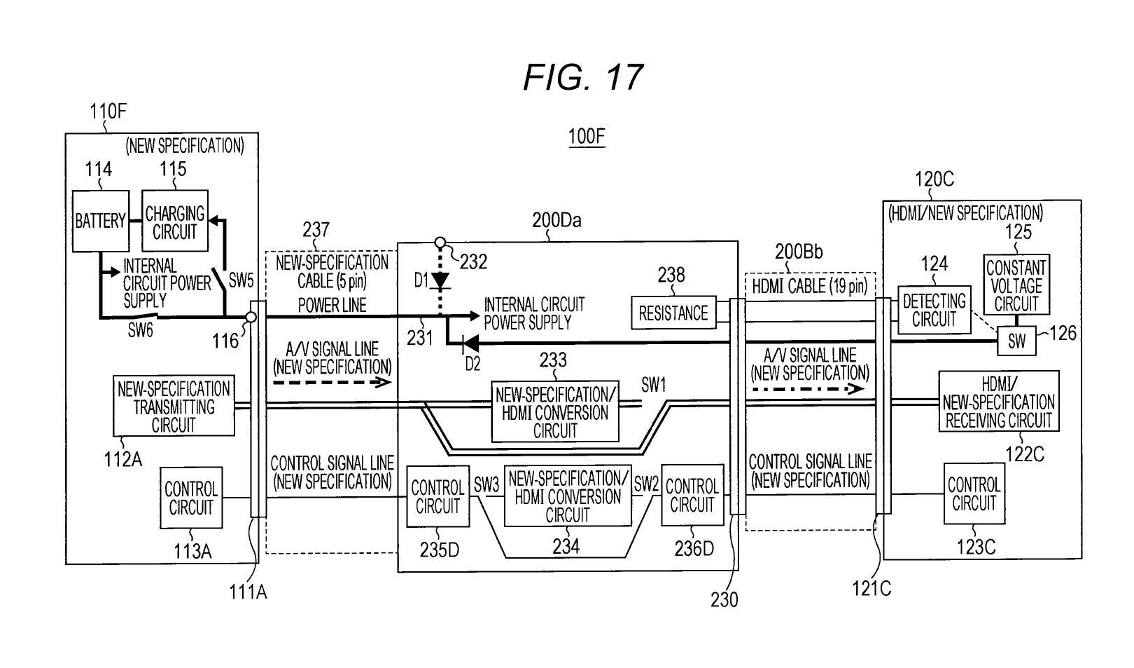

FIG. 17 shows an exemplary configuration of an AV system 100F in which it is possible to receive power from a source device (mobile phone). In this FIG. 17, the same reference signs are appended to the portions that correspond to FIG. 14, and a detailed description thereof is omitted as appropriate. This AV system 100F is configured with a mobile phone 110F serving as a source device and a television receiver 120C serving as a sink device being connected. The mobile phone 110F is compatible with the new specification, and the television receiver 120C is compatible with both the new specification and HDMI. The mobile phone 110F and the television receiver 120C are connected by the series circuit of a dongle 200Da serving as a signal conversion device, and an HDMI cable 200Bb.

The AV system 100F shown in FIG. 17 is configured in the same way and operates in the same way as the AV system 100D shown in FIG. 14, except for the mobile phone 110F. The mobile phone 110F will now be described. The mobile phone 110F includes a new-specification transmitting circuit 112A, a control circuit 113A, a battery 114, a charging circuit 115, and a power terminal 116. The charging circuit 115 is a circuit for charging the battery 114. The power terminal 116 is one terminal (pin) of a receptacle, and is a terminal to which a power line is connected when a plug of a new-specification cable 237 is connected to the receptacle by a connector unit 111A.

In the mobile phone 110F, the power terminal 116 is connected to the charging circuit 115 via a switch circuit SW5. Furthermore, the output of the battery 114 is connected to the power terminal 116 via a switch circuit SW6. The control circuit 113A controls the connection/disconnection of the switch circuits SW5 and SW6. The control circuit 113A determines whether or not the voltage of the power terminal 116 is lower than a specified value by a connection state (first connection state) in which the switch circuit SW6 is disconnected and the switch circuit SW5 is connected.

The control circuit 113A maintains the aforementioned first connection state when the voltage is equal to or greater than the specified value, but when the voltage is lower than the specified value, the control circuit 113A performs switching in such a way that a connection state in which the switch circuit SW6 is connected and the switch circuit SW5 is disconnected (second connection state) is selected. Although a detailed description is omitted, the rest of the mobile phone 110F is configured in the same way as the mobile phone 110A of the AV system 100D of FIG. 14.

In the AV system 100F shown in FIG. 17, for example, if the television receiver 120C is not connected to the dongle 200Da, the voltage of the power line 231 of the dongle 200Da, and therefore the voltage of the power terminal 116 of the mobile phone 110F, is lower than the specified value. Therefore, switching is performed, by the control circuit 113A, to the connection state in which the switch circuit SW6 is connected and the switch circuit SW5 is disconnected (second connection state).

Power is thereby supplied from the battery 114 of the mobile phone 110F, through the switch circuit SW6, the power terminal 116, and the power line of the new-specification cable 237, to the power line 231 of the dongle 200Da. Therefore, the dongle 200Da is able to operate even in a state in which an external power source is not connected and, furthermore, there is no power supply from the television receiver 120C.

In this state, if the television receiver 120C is connected to the dongle 200Da, as mentioned above, a state is entered in which power is supplied from a constant voltage circuit 125 of the television receiver 120C to the power line 231 of the dongle 200Da. If the television receiver 120C is connected, the connection of the television receiver 120C, in other words the power supply from the television receiver 120C, is notified to the control circuit 113A by communication between the control circuit 235D of the dongle 200Da and the control circuit 113A of the mobile phone 110F.

The control circuit 113A of the mobile phone 110F that receives the television receiver 120C connection notification performs switching in such a way that the connection state in which the switch circuit SW6 is disconnected and the switch circuit SW5 is connected (first connection state) is selected. A state is therefore entered in which power from the television receiver 120C is supplied to the mobile phone 110F via the dongle 200Da.

Furthermore, in the aforementioned embodiment, an example has been given in which the source device is a mobile phone and the sink device is a television receiver. However, the signal conversion device (dongle) of the present technology can of course be applied in the same way also in the cases where the source device and the sink device are other electronic devices.

Furthermore, in the aforementioned embodiment, an example has been given in which the first transmission specification is a new specification (see FIG. 5), and the second transmission specification is HDMI (see FIG. 2). However, in the present technology, the first transmission specification and the second transmission specification are not restricted to these.

Furthermore, the present technology can also have configurations such as the following.

(1) A signal conversion device including:

a signal conversion unit that converts a first transmission specification signal that is input from a first external device, into a second transmission specification signal;

a signal selection unit that selects, as an output signal, the first transmission specification signal that is input from the first external device or the second transmission specification signal that is obtained by the signal conversion unit; and

a control unit that controls the selection operation performed by the signal selection unit, in accordance with a transmission specification with which a second external device, to which the output signal selected by the signal selection unit is to be supplied, is compatible.

(2) The signal conversion device according to (1),

wherein, when the second external device is compatible with the first transmission specification, the control unit controls in such a way that the signal selection unit selects the first transmission specification signal as the output signal.

(3) The signal conversion device according to (2),

wherein the control unit detects the impedance of the second external device, and thereby determines whether or not the second external device is compatible with the first transmission specification.

(4) The signal conversion device according to any of (1) to (3),

wherein, in the transmission specifications, video data and audio data are transmitted on a differential signal line, and, in addition, a control signal is transmitted on a separate signal line.

(5) The signal conversion device according to (4),

wherein,

in the first transmission specification, the first transmission specification signal is transmitted using a first number of signal lines, and,

in the second transmission specification, the second transmission specification signal is transmitted using a second number of signal lines that is greater than the first number.

(6) The signal conversion device according to (5),

wherein,

in the first transmission specification, the video data and the audio data are transmitted using one pair of differential signal lines, and,

in the second transmission specification, the video data and the audio data are transmitted using three pairs of differential signal lines.

(7) The signal conversion device according to any of (1) to (6),

further including a power receiving unit that receives, from the first external device or the second external device, power to be supplied to an internal circuit.

(8) The signal conversion device according to (7),

further including a power line for supplying power to the internal circuit and the first external device,

wherein power is supplied from the second external device to the power line when the second external device is compatible with the first transmission specification.

(9) The signal conversion device according to (8),

further including a resistor for prompting the second external device to supply power,

wherein the second external device supplies power to the power line by detecting the resistor.

(10) The signal conversion device according to (8) or (9),

further comprising:

a power input unit for supplying power from an external power source to the power line; and

a power interference prevention unit that prevents interference between power input from the second external device and power input from the external power source.

(11) The signal conversion device according to (10),

wherein the power interference prevention unit is a diode bridge including a first diode that is inserted in a power supply path from the second external device to the power line, and a second diode that is inserted in a power supply path from the power input unit to the power line.

(12) A signal conversion method including:

a signal conversion step of converting a first transmission specification signal that is input from a first external device, into a second transmission specification signal;

a signal selection step of selecting, as an output signal, the first transmission specification signal that is input from the first external device or the second transmission specification signal that is obtained in the signal conversion step; and

a control step of controlling the selection operation performed in the signal selection step, in accordance with a transmission specification with which a second external device, to which the output signal selected in the signal selection step is to be supplied, is compatible.

(13) A terminal device including:

a battery;

a charging unit that charges the battery;

a power terminal;

a state selection unit that selects a first connection state in which the power terminal is connected to the charging unit or a second connection state in which output of the battery is connected to the power terminal; and

a control unit that controls the selection operation performed by the state selection unit,

wherein the control unit controls the selection operation performed by the state selection, in such a way that the second connection state is selected when a voltage of the power terminal is lower than a specified value in a state in which the first connection state is selected.

(14) The terminal device according to (13), wherein,

when the second connection state is selected, the control unit controls the selection operation performed by the state selection unit, in such a way that the first connection state is selected, on the basis of a notification of power supply from an external device that supplies power to the power terminal.

(15) The terminal device according to (14),

further including a signal output unit that outputs a first transmission specification signal,

wherein the external device has a function that converts the first transmission specification signal that is output from the signal output unit, into a second transmission specification signal.

### REFERENCE SIGNS LIST

100D, 100F AV system
110A, 110F Mobile phone
111A, 121C, 230 Connector unit
112A New-specification transmitting circuit
113A, 123C, 235D, 236D Control circuit
114 Battery
115 Charging circuit
116 Power terminal
120C Television receiver
122C HDMI/new-specification receiving circuit
124 Detecting circuit
125 Constant voltage circuit
126 Switch circuit
200Bd HDMI cable
200Da Dongle (signal conversion device)
231 Power line
232 Power input unit
233, 234 New-specification/HDMI conversion circuit
237 New-specification cable
238 Resistance
300 External power source

1. A signal conversion device comprising:
a signal conversion unit that converts a first transmission specification signal that is input from a first external device, into a second transmission specification signal;
a signal selection unit that selects, as an output signal, the first transmission specification signal that is input from the first external device or the second transmission specification signal that is obtained by the signal conversion unit; and
a control unit that controls the selection operation performed by the signal selection unit, in accordance with a transmission specification with which a second external device, to which the output signal selected by the signal selection unit is to be supplied, is compatible.

2. The signal conversion device according to claim 1,
wherein, when the second external device is compatible with the first transmission specification, the control unit controls in such a way that the signal selection unit selects the first transmission specification signal as the output signal.

3. The signal conversion device according to claim 2,
wherein the control unit detects the impedance of the second external device, and thereby determines whether or not the second external device is compatible with the first transmission specification.

4. The signal conversion device according to claim 1,
wherein, in the first transmission specification and the second transmission specification, video data and audio data are transmitted on a differential signal line, and, in addition, a control signal is transmitted on a separate signal line.

5. The signal conversion device according to claim 4,
wherein,
in the first transmission specification, the first transmission specification signal is transmitted using a first number of signal lines, and,
in the second transmission specification, the second transmission specification signal is transmitted using a second number of signal lines that is greater than the first number.

6. The signal conversion device according to claim 5,
wherein,
in the first transmission specification, the video data and the audio data are transmitted using one pair of differential signal lines, and,
in the second transmission specification, the video data and the audio data are transmitted using three pairs of differential signal lines.

7. The signal conversion device according to claim 1,
further comprising a power receiving unit that receives, from the first external device or the second external device, power to be supplied to an internal circuit.

8. The signal conversion device according to claim 7,
further comprising a power line for supplying power to the internal circuit and the first external device,
wherein power is supplied from the second external device to the power line when the second external device is compatible with the first transmission specification.

9. The signal conversion device according to claim 8,
further comprising a resistor for prompting the second external device to supply power,
wherein the second external device supplies power to the power line by detecting the resistor.

10. The signal conversion device according to claim 8,
further comprising:
a power input unit for supplying power from an external power source to the power line; and
a power interference prevention unit that prevents interference between power input from the second external device and power input from the external power source.

11. The signal conversion device according to claim 10,
wherein the power interference prevention unit is a diode bridge comprising a first diode that is inserted in a power supply path from the second external device to the power line, and a second diode that is inserted in a power supply path from the power input unit to the power line.

12. A signal conversion method comprising:
a signal conversion step of converting a first transmission specification signal that is input from a first external device, into a second transmission specification signal;
a signal selection step of selecting, as an output signal, the first transmission specification signal that is input from the first external device or the second transmission specification signal that is obtained in the signal conversion step; and
a control step of controlling the selection operation performed in the signal selection step, in accordance with a transmission specification with which a second external device, to which the output signal selected in the signal selection step is to be supplied, is compatible.

13. A terminal device comprising:
a battery;
a charging unit that charges the battery;
a power terminal;
a state selection unit that selects a first connection state in which the power terminal is connected to the charging unit or a second connection state in which output of the battery is connected to the power terminal; and
a control unit that controls the selection operation performed by the state selection unit,
wherein the control unit controls the selection operation performed by the state selection, in such a way that the second connection state is selected when a voltage of the power terminal is lower than a specified value in a state in which the first connection state is selected.

14. The terminal device according to claim 13,
wherein, when the second connection state is selected, the control unit controls the selection operation performed by the state selection unit, in such a way that the first connection state is selected, on the basis of a notification of power supply from an external device that supplies power to the power terminal.

15. The terminal device according to claim 14,
further comprising a signal output unit that outputs a first transmission specification signal,
wherein the external device has a function that converts the first transmission specification signal that is output from the signal output unit, into a second transmission specification signal.
